(19) United States
(12) Patent Application Publication
(10) Pub. No.: US 2018/0285241 A1
(43) Pub. Date: Oct. 4, 2018

(54) ENERGY-INTERFERENCE-FREE DEBUGGER FOR INTERMITTENT ENERGY-HARVESTING SYSTEMS

(71) Applicant: CARNEGIE MELLON UNIVERSITY, Pittsburgh, PA (US)

(72) Inventors: Brandon Lucia, Pittsburgh, PA (US); Alanson Sample, Pittsburgh, PA (US)

(21) Appl. No.: 15/938,216

(22) Filed: Mar. 28, 2018

Related U.S. Application Data
(60) Provisional application No. 62/601,682, filed on Mar. 28, 2017.

(51) Int. Cl. G06F 11/36; G06F 11/07

(52) U.S. Cl. CPC G06F 11/3644; G06F 11/3656; G06F 11/364; G06F 11/0766

(57) ABSTRACT

An energy-interference-free debugger is disclosed for debugging software resident on energy-harvesting target devices, which may periodically lose power and therefore exhibit intermittent execution of the software. The debugger is implemented as a combination of hardware and software and provides, in addition to the traditional debugging tools, the ability to monitor and modify the energy level on the target device, the ability to set breakpoints based on the energy level on the target device, and the ability to isolate portions of the code executing on the target device from energy-related failure during debugging. The debugger is able to remain isolated from intermittent power in passive mode and to create an illusion of an untouched energy reservoir in active mode.

### RELATED APPLICATIONS

This application claims the benefit of U.S. Provisional Patent Application Ser. No. 62/601,682, filed Mar. 28, 2017.

### FIELD OF THE INVENTION

This invention is related to energy-autonomous systems, for example, energy-harvesting systems, and, in particular, to the problem of debugging software and firmware that operates and controls these systems.

### BACKGROUND OF THE INVENTION

Energy-autonomous computing devices have the potential to extend the reach of computing to a scale beyond either wired or battery-powered systems. However, these devices pose a unique set of challenges to application developers who lack both hardware and software support tools. Energy harvesting devices experience power intermittence which cause the system to reset and power-cycle unpredictably, in some cases tens to hundreds of times per second. This can result in code execution errors that are not possible in continuously powered systems and that cannot be diagnosed with conventional debugging tools such as JTAG and/or oscilloscopes.

Energy-harvesting devices are embedded computing systems that eschew tethered power and batteries by harvesting energy from the environment. A power system collects energy into a storage element (i.e., a capacitor) until the buffered energy is sufficient to power the computing device. Once powered, the device can operate until its energy is depleted and power fails. After the failure, the cycle of charging begins again. These charge-discharge cycles power the system intermittently and, consequently, software that runs on an energy-harvesting device also executes intermittently. A power failure may interrupt an execution with a reboot at any point. A reboot clears volatile state, for example, data stored a register file or SRAM, and retains non-volatile state, for example, data stored in FRAM. When the system restarts, control is transferred to some earlier point in the program, for example, the start of the main routine.

Intermittence makes software difficult to write and un-derstand. A reboot can happen at any point in a program's code, and may occur tens or hundreds of times per second. Reboots complicate a program's possible behavior because reboots are implicit discontinuities in the program's control flow that are not expressed anywhere in the code. Even with checkpointing and versioning, reboots cause control flow unintuitively back to a previous point in the execution.

Intermittence can cause correct software to misbehave. Intermittence-induced jumps back to a prior point in execution inhibit forward progress and may cause repeated execution of code that should not be repeated. Intermittence can also leave memory in an inconsistent state that would not normally occur in a continuously powered execution. These failure modes represent a new class of intermittence bugs. To avoid intermittence-related malfunctions, code must correctly leverage non-volatile memory. Writing intermittence-safe code for an energy-harvesting application or runtime system requires the programmer to understand, find, and fix intermittence bugs.

To diagnose bugs in their code, programmers need to monitor system behavior, observe failures, and examine internal program state. Unfortunately, this simple debugging methodology is unusable for intermittence bugs in energy-harvesting devices because existing debugging tools power the target device, masking the intermittent behavior. As a result, programmers are left with an unsatisfying dilemma: to use a debugger to monitor the system and never observe a failure, or to run without a debugger and observe the failure but gain no insight into the system necessary for understanding the bug.

As an example, assume an energy-intermittent system that executes a C program that takes longer than a single charge-discharge execution cycle to complete. The device may have a mixture of volatile registers and memory, as well as some non-volatile memory. Further, assume a checkpointing mechanism that periodically collects a checkpoint of volatile execution context (i.e., register file and stack).

Power intermittence complicates understanding and debugging a system, because the behavior of an intermittent system is closely linked to its power supply. This link is illustrated in FIG. 1. A simplified energy-harvesting circuit is shown in FIG. 1A. An ambient energy transducer (e.g., solar, RF, vibration) connects to an energy storage element (e.g., a capacitor), and a load (e.g., a microcontroller). Unlike a battery, the ambient energy source has a high source resistance that limits its usable power, resulting in the characteristic “sawtooth” RC charging behavior shown in FIG. 1B. The system charges its capacitor until there is enough energy and voltage to operate. Then, active operation begins and the capacitor starts to discharge (shaded areas). The device continues actively until the voltage on the storage capacitor drops below a minimum operating threshold (dashed line), at which point the system loses power and begins another charging cycle. This repeated charging and discharging of the device forces software into an intermittent execution model where periods of powered execution are interspersed with reboots.

FIG. 2 illustrates how intermittence induces bugs even with runtime support for checkpointing volatile state into non-volatile memory. The code manipulates a linked-list in non-volatile memory using append and remove functions. A continuous execution completes the code sequentially, as expected. An intermittent execution, however, is not sequential. In the leftmost trace, a checkpoint happens to be collected at the top of the while loop and the processing continues until power fails at the “Brown Out” point in FIG. 1. After the reboot, execution resumes from the checkpoint. This sequence of events later leads to undefined behavior. The execution violates the pre-condition assumed by the remove routine that only the tail's next should be NULL. The reboot interrupts the append routine before it can make node “e” the list's new tail but after its next pointer is set to NULL. When execution resumes at the checkpoint, it attempts to remove node “e” again. The conditional in the remove routine confirms that “e” is not the tail, then de-references its next pointer (which is NULL). The NULL next pointer makes e->next->prev a wild pointer that, when written, leads to undefined behavior. This NULL pointer de-reference does not occur in normal continuous execution and is an example of an intermittence bug.

Debugging intermittence bugs, like the example shown in FIG. 2, using existing tools is virtually impossible. Conventional de-buggers supply power to the device-under-test (DUT), which precludes observation of a realistically intermittent execution.

One approach to diagnosing an intermittence bug is to directly write debugging instrumentation code into an application to trace certain program events. In embedded systems, one popular ad hoc approach is to toggle an LED at a point of interest. LED-based tracing, however, does not work in energy-harvesting devices, because the energy required to power the LEDs changes the behavior of the system.

Another tracing strategy is to manually instrument code to log program events to non-volatile memory. The resulting trace, however, lacks information about the energy level, unless the developer also spends time, energy, and an ADC channel to log the DUT's energy state. Non-volatile tracing also consumes precious non-volatile storage space. To avoid consuming non-volatile storage space, a programmer may write code to stream the event log to a separate, always-on system (e.g., via UART). Powering and clocking an I/O peripheral to transfer the log is also time and energy expensive and adds considerable complexity to code.

All of the instrumentation-based approaches change the point in the program at which energy is exhausted. As a result, the act of debugging alters the intermittent behavior of the application. Furthermore, the value of tracing depends on the events which the programmer decides to trace. To understand the intermittence bug in FIG. 2, for example, the programmer needs to log particular events in the append and remove routines. The bug manifests as a wild pointer write and may cause the program to appear to crash inexplicably, in code far from the either of those routines, providing little to suggest that the append and remove routine contain the culpable code.

Energy-interference and lack of visibility into intermittent executions makes prior approaches to debugging inadequate for intermittence debugging. Therefore, it would be desirable to provide a means for debugging an energy-intermittent system that does not interfere with the power profile of the system.

### SUMMARY OF THE INVENTION

Disclosed herein is an energy-interference-free debugger, a hardware and software platform for monitoring and debugging energy-intermittent systems without adversely affecting their energy state. The energy-interference-free debugger (EDB) re-creates a familiar debugging environment for energy-intermittent software and augments it with debugging primitives for effective diagnosis of intermittence bugs and addresses the current lack of basic debugging support for energy-intermittent systems.

The EDB is a complement of hardware and software for energy-interference-free monitoring and manipulation of intermittent devices. EDB can passively monitor a target device for its energy level, I/O events (e.g., I²C, RFID) and program events. Monitoring with EDB, unlike with conventional debuggers, is energy-interference-free, because it is designed to be electrically isolated from the target device. EDB also provides a capability to actively manipulate the amount of energy stored on the device. Using this mechanism, EDB can compensate for the energy consumed by arbitrarily expensive tasks, effectively eliminating their impact on the energy state experienced by the program.

Many important debugging tasks in energy-intermittent systems are impossible without energy-interference-free monitoring and manipulation mechanisms. Passive monitoring allows concurrent tracing of energy, program events, and I/O under realistic scenarios. EDB's energy manipulation and compensation mechanism lets a programmer instrument application code with energy-intensive invariant checks (e.g., asserts) and trace statements (e.g., printfs) without impacting the behavior of the system. The same mechanisms enable interactive debugging with breakpoints that can be conditioned on energy level and with access to the state of the target device.

Energy-interference-freedom is essential for debugging intermittent, energy-harvesting systems. EDB provides this capability, providing debugging primitives for intermittent software, including energy-aware breakpoints, keep-alive assertions, and energy guards.

### BRIEF DESCRIPTION OF THE DRAWINGS

FIG. 1A shows a simplified circuit diagram of an energy harvesting device.

FIG. 1B depicts a characteristic charge and discharge cycles which may define the intermittent operation of the circuit in FIG. 1A.

FIG. 2 depicts an intermittence bug. The linked-list stays correct with continuous power but is corrupted and leads to a wild pointer write with intermittent power.

FIG. 3 illustrates the features and supported debugging tasks of the energy-interference-free debugger.

FIG. 4 is a block diagram of EDB connected to an RF energy-harvesting target. All signal lines are buffered to minimize energy interference. A charge/discharge circuit controls the voltage on the target's energy storage capacitor.

FIG. 5 is a code snippet showing an intermittence bug that corrupts memory, diagnosed using EDB's intermittence-aware assert and interactive console.

FIG. 6 shows oscilloscope traces of a memory-corrupting intermittence bug and EDB's intermittence-aware assert in action. Without the assert (6A) the main loop runs at first (left) but then stops running in later discharge-cycles (right). With the assert (6B), when it fails at instant 1, EDB halts the device and tethers it to a continuous power supply.

FIG. 7 shows an application code snippet instrumented with a consistency check of arbitrary energy cost using EDB's energy guards.

FIG. 8 shows oscilloscope traces of an application instrumented with a consistency check of high energy cost. Without an energy guard (8A), the check and main loop both execute at first (left) but only the check executes in later discharge-cycles (right). With an energy guard (8B), the check executes on tethered power from instant I to 2 And 3 to 4, and the main loop always executes.

FIG. 9 is a code snippet from a tracing and profiling an activity recognition application using EDB's energy-interference-free printf and watchpoints.

FIG. 10 is a graph of the energy profiles of one loop iteration in the activity recognition application when instrumented with different output mechanisms.

FIG. 11 shows incoming and outgoing RFID messages correlated with energy level recorded by EDB.

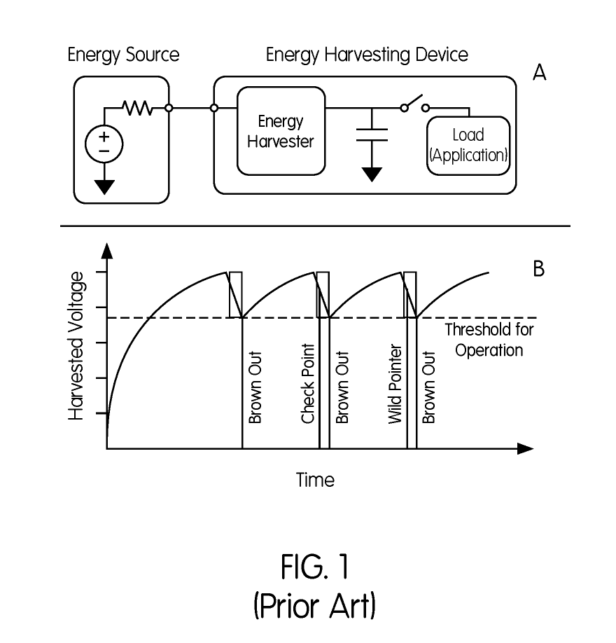

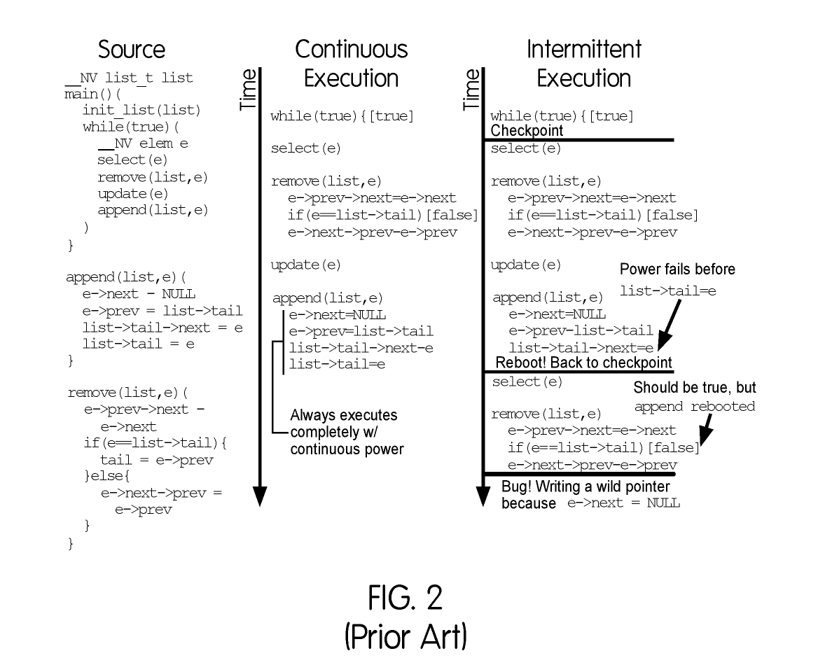

### DETAILED DESCRIPTION

EDB is an energy-interference-free debugging platform for intermittence debugging that addresses the difficulties described above. EDB is a co-designed hardware and software implementation that makes EDB energy-interference-free debugging possible.

EDB comes in the form of an independently-powered hardware module including a CPU executing the software necessary for interfacing with the target device. An external monitor can be connected to the hardware module to provide a user interface for interactive debugging functions. The hardware module interfaces with the target device via a plurality of interfaces, including general-purpose I/O (GPIO), universal asynchronous receiver-transmitter (UART), an I²C interface. All connections between EDB and the target device are electrically isolated using low-leakage diodes on interface pins to avoid having EDB sourcing current from the target device and/or providing current to the target device. The I/O pins on the interfaces available on the EDB can be mapped via the onboard software to interface with any available I/O point on the target device.

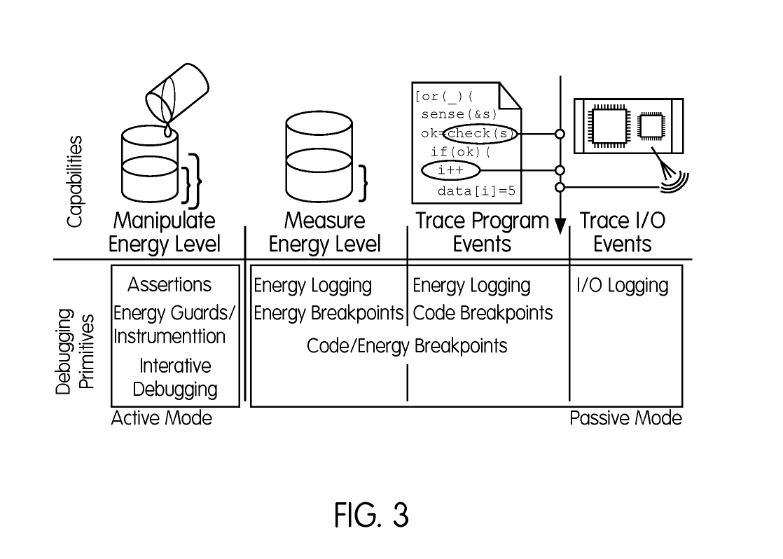

FIG. 3 illustrates EDB functionally. At the top are EDB's capabilities that together support the debugging primitives at the bottom. The functionality is organized into two parts. The first part is support for passively monitoring the energy level of a device, program events and I/O, which are referred to as EDB's “passive mode” of operation. The second part is a complementary “active mode” with support for actively monitoring and manipulating the target device's energy level and internal state (e.g., registers and memory). The passive and active mode capabilities are combined to implement energy-interference-free debugging primitives, including energy and event tracing, intermittence-aware breakpoints, energy-aware breakpoints, energy guards for instrumentation, and interactive debugging.

Passive Mode Operation—

EDB's passive mode operation is built around the three right-most components at the top of FIG. 3. The developer has the ability to acquire a set of streams and relay them to the host workstation continuously in real-time without active involvement from the target device whether it is on or off. Streams instrumental for debugging are the energy level, I/O events on wired buses, messages exchanged over RFID protocol, and program events marked by watchpoints in application code. EDB is able to gather this data concurrently, allowing the developer to correlate changes in system behavior with changes in energy state. That correlation is important during development, but difficult or impossible using existing techniques.

Active Mode Operation—

The capability to manipulate the amount of energy stored on the target device is the key to EDB's active mode of operation. Active mode frees debugging tasks from the constraint of the small energy store of the target device. EDB can compensate for the energy consumed by a debugging task that involves a costly operation on the target device, such as interacting with the programmer, executing arbitrary debug code, or conveying state to the debugger. Before performing an active task, the energy on the target device is measured and recorded. While the active task executes, the target is continuously powered. After performing the active task, the energy on the target device is restored to the level measured before the active task. Continuously powering active tasks enables them to consume arbitrary amounts of energy. Energy compensation provides the illusion of an unaltered, intermittent execution of the application. Without this support, debugging tasks that require considerable involvement from the target are not possible.

Energy-Interference-Free Debugging Primitives—

Using the monitoring and manipulation capabilities described thus far, EDB creates a toolbox of energy-interference-free debugging primitives. EDB brings familiar debugging techniques that are currently confined to continuously-powered platforms to intermittent platforms. Additionally, new intermittence-aware primitives are introduced to handle debugging tasks that arise only on intermittently-powered platforms.

Code and Energy Breakpoints—

EDB implements three types of breakpoints. A code breakpoint is a conventional breakpoint that triggers at a specified code point. An energy breakpoint triggers when the target device's energy level is at or below a specified threshold. A combined breakpoint triggers when a specified code point executes and the target device's energy level is at or below a specified threshold. Breakpoints conditioned on energy level can help catch energy leaks due to unexpected code paths. They initiate an interactive debugging session precisely in problematic iterations when more energy was consumed than expected or when the device is about to brown-out.

Keep Alive Assertions—

EDB provides support for using familiar assertions on intermittent platforms. When an assertion fails, EDB immediately tethers the target device to a continuous power supply to prevent it from losing state by browning out. This keep-alive feature turns what would have to be a post-mortem reconstruction of events into an investigation on a live device. A post-mortem analysis is limited to scarce clues in a tiny ad hoc “core dump” that a custom fault handler has managed to save into non-volatile state before the target device runs out of energy and resets. The clues available in the interactive debugging session automatically opened by EDB for a failing assert include the entire live target address space and I/O buses to peripherals.

Energy Guards—

EDB can hide the energy cost of an arbitrary region of code if enclosed between a pair of energy guards. Code within energy guards executes on tethered power. Code on either side of an energy-guarded region experiences an illusion of continuity in the energy level across the energy-guarded region as if no energy was consumed. EDB implements energy guards using its energy compensation mechanism by recording the target energy level upon entering an energy-guarded region of code and restoring the energy level upon exiting the energy-guarded region of code. Without energy cost, instrumentation code becomes non-disruptive and therefore useful on intermittent platforms. Two especially valuable forms of instrumentation impossible without EDB are complex data structure invariant checks and external event tracing. Extra code added to an application to check invariants on data structures or report when certain events have executed via an I/O mechanism (e.g. printf, LED) can be costly enough to repeatedly deplete the target energy supply and prevent forward progress.

Besides instrumentation, EDB energy guards may also assist with the incorporation of non-intermittence-safe third-party code into intermittent applications. As long as third-party library calls are wrapped in energy guards, intermittence failures are guaranteed to not occur within the library. Functionality can now be developed separately from handling intermittence. Similarly, energy guards are useful for gradually porting code from a continuously powered platform to an energy-intermittent platform. A programmer can start with an energy guard around the entire program and repeatedly exclude modules from the guarded region after verifying the correctness of the module under intermittence, until the entire application is out of the guarded region and intermittence-safe.

Interactive Debugging—

EDB supports interactive debugging of a target device from a work-station. An interactive session provides full access to view and modify the target's memory, as with a conventional debugger. A developer can enable code-energy breakpoints and can manually manipulate the target's energy level. An interactive session is entered automatically when a breakpoint is hit, when an assertion fails or on demand by a console command. A unique benefit of EDB is its ability to trigger a manipulation of the target's energy state based on the target's program behavior and vice versa.

Hardware/Software Implementation—

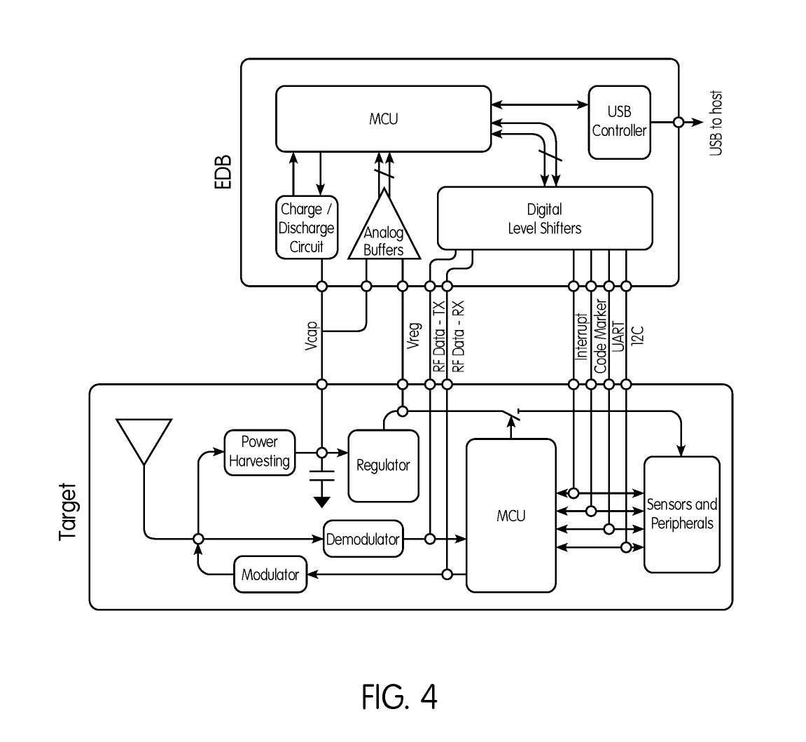

FIG. 4 shows a block diagram of EDB connected to an RF energy-harvesting target. EDB's capabilities and debugging primitives are implemented in custom co-designed hardware and software. The labeled wires are physical connections between EDB and the target that carry both analog and digital signals and are exposed through header pins. The hardware board can connect to any energy-harvesting device with a microcontroller and a capacitor. To support a new device, the applicable physical connections from FIG. 4 must be wired and a target-side EDB software library must be ported to the new architecture.

Energy Level Monitoring—

Energy-interference-free measurement of the target device's energy level is essential to EDB's passive mode of operation. To measure a device's energy level, EDB uses two physical connections, V_{cap} and V_{reg}, to the target device's energy storage capacitor and its regulated power line, respectively. These signals pass through a dual high impedance, unity gain instrumentation amplifier to minimize leakage current from the target device to the EDB. These analog voltages are digitized by an analog to digital converter (ADC) and are logged or used internally for debugging tasks. While it is possible for energy harvesting devices to measure their own stored energy levels, doing so uses energy, perturbing the energy state being measured and altering the intermittent behavior of the software.

Energy Manipulation and Compensation—

Energy manipulation and compensation are the basis for EDB's active mode of operation. EDB has a custom circuit consisting of a low pass filter, a keeper diode, and GPIO pins that can charge and discharge the target device's energy storage capacitor. This circuit is designed to prevent loading down or trickle charging the target device while inactive (i.e., in a high impedance state).

To charge (or discharge) the target device to a desired voltage level, EDB activates a GPIO pin to raise (or lower) the voltage on the target device's energy storage capacitor. A basic iterative control loop in EDB's software ensures that the voltage converges to the desired level. Discharging works similarly: the target's energy storage capacitor discharges through a fixed resistive load and a software control loop ensures convergence to the desired level. Initially, the charging circuit assumes a capacitive storage element, but with software changes, the same design can support other power storage media, such as thin-film batteries.

I/O Monitoring—

EDB enables passive monitoring of arbitrary I/O and attached peripherals, such as sensors, communication buses, and radios. These digital signals, shown in FIG. 4 as “RF Data Tx”, “RF Data Rx”, “UART”, and “I2C” connect to a digital buffer and level shifter. An extremely low-leakage buffer is used to prevent leakage current from the target device to EDB, and the level shifter is used to match the buffer's voltage level to the target device's voltage level.

Note that, while the target device has an on-board regulator, the V_{reg} line may drop below its specified, regulated value during a power failure on the target device. The V_{reg} drop is addressed with a simple tracking circuit consisting of an analog buffer to keep the level shifter at the target device's voltage. This circuit is important because too large a mismatch (i.e., over +/−0.3V) may activate the voltage protection diodes in the target device's MCU, which perturbs the target device's power state.

EDB can monitor GPIO, UART, I2C, and RFID RX/TX data lines. A key benefit of EDB is that it monitors data communication lines externally. With external monitoring, messages (e.g., RFID messages) can be decoded even if the target device does not correctly decode them due to power failures. EDB's I/O monitoring support aids developers in I/O calibration and debugging I/O related issues in software.

Program Event Monitoring—

EDB can track program execution using the Code Marker connections shown in FIG. 4. To monitor a code point, the programmer inserts a watchpoint with a unique identifier at the specified location in the code of the target device. EDB's target device-side software encodes this identifier onto the Code Marker lines when the program counter passes over the specified code point. On the debugger-side, transitions on the Code Marker lines are captured and decoded into watchpoint identifiers. EDB can simultaneously monitor 2ⁿ−1 distinct watchpoints, where n is the number of GPIO lines allocated to the Code Marker function.

Monitoring program events using EDB is virtually energy-interference-free. The main energy cost is the target device holding a GPIO pin high for one cycle to encode each traced code point as it executes. The cost of this GPIO-based signaling was found to be negligible. Without EDB, monitoring has a prohibitive cost in code, memory pace, and energy. However, with EDB, events are not only logged without these costs, but also correlated with energy state into a multi-faceted profile.

Developer's Interfaces into EDB—

The debugging primitives provided by EDB are accessible to the end-user through two complimentary interfaces: the libEDB API and the host console commands listed in Table 1. The libEDB library statically links into the on-board software controlling the target device and exports C macros for inserting assertions, breakpoints, watchpoints, energy guards, and energy-interference-free printf calls into the code of the target device. Internally, the library implements the target-side half of the protocol for communicating with the debugger over a dedicated GPIO line and a UART link, which includes routines for reading from and writing to target address space. Preferably, the library is integrated into the software controlling the target device and downloaded to the target device along with that software.

TABLE 1
Developer's interfaces into EDB.

| libEDB API | Debug Console Commands |
|---|---|
| assert(expr) | charge\|discharge energy_level |
| break\|watch_point(id) | break\|watch an\|dis id [energy_level] |
| energy_guard(begin\|end) | trace {energy,iobus,rfid,watchpoints} |
| printf(fat, . . . ) | read\|write address [value] |

The debug console is a command-line interface for interacting directly with EDB and indirectly with the target device over a USB connection from a workstation. During interactive de-bugging in active mode, the console reports assert failures and breakpoint hits and provides commands to inspect target device memory. During passive mode debugging, the console delivers traces of energy state, watchpoint hits, monitored I/O events, and the output of printf calls. EDB can emulate intermittence at the granularity of individual charge-discharge cycles using the charge/discharge commands.

Implementation Details and Release—

EDB was prototyped as a printed circuit board (PCB) that connects to the target device via a board-to-board header. The core design is also compatible with an implementation as an on-chip component within the target device architecture. EDB software includes firmware and the libEDB, both written in C, and code for the scripting API and host console, both written Python.

Debugging Capabilities—

EDB provides new debugging capabilities to the development of software for intermittent-energy systems. There are several debugging tasks that are particularly difficult to resolve using state-of-the-art tools. Energy-harvesting applications in the following scenarios execute intermittently and keep state in non-volatile memory to make progress without relying on a runtime checkpointing system. A reboot causes execution to return to the program entry point (i.e., the main routine).

Early Detection of Memory Corruption—

Memory corruption due to incorrect pointer arithmetic or a buffer overflow is a frequent yet difficult problem to debug. The root cause is obscured behind symptoms that are far from the offending memory write in both time and in space. Memory corruption induced by intermittence is even harder to diagnose, because it is not reproducible in a conventional debugger. An example of an application is presented that fails due to an intermittence-induced memory corruption and demonstrates how EDB's support for assertions exposes the root cause.

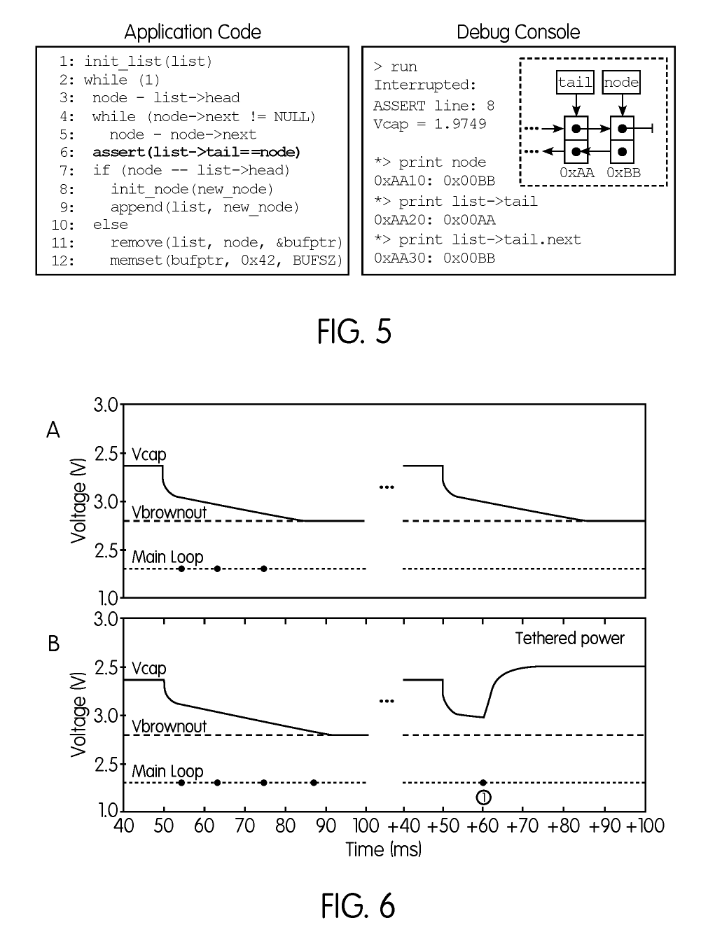

The code snippet listed in the left pane of FIG. 5 maintains a doubly-linked list data structure in non-volatile memory. On each iteration of the main loop, a node is appended to the linked list if the list is empty or removed from the list otherwise. The node is initialized with a pointer to a buffer in volatile memory. This pointer is retrieved when the node is removed from the list and data is written to the buffer it points to. The role of the memory buffer in this example is to expose undefined behavior during access to the linked list, which takes place with or without the buffer, as an externally observable failure. For illustrative purposes, at the beginning and end of the loop iteration, the code toggles a GPIO pin to indicate that the main loop is running.

After having run on harvested energy for some amount of time, the GPIO pin indicating main loop progress stops toggling. The real oscilloscope trace shown in FIG. 6A shows an early charge-discharge cycle when the main loop is still executing and a later one when it no longer does. After the main loop stops executing, the application never returns to normal, including after reboots on subsequent charge-discharge cycles. The only way to recover is to re-flash the device. Note that the failure problem never occurs when the device runs on continuous power.

Because the broken final state persists across re-boots, one approach is to attach a conventional debugger after the failure and attempt to determine why the main loop stopped running. This approach may help uncover the symptom, but not the root cause, because the information that happens to persist in memory may not be sufficient to follow the chain of events backwards in time. A better approach is to catch the problem at its source by asserting an invariant on the linked-list data structure whenever it is manipulated. However, conventional assertions fall short in this case, because they let the target drain the energy supply, reset, and continue past a failed assertion.

EDB's intermittence-aware assert mechanism is designed to tackle this class of bugs. The invariant that the tail pointer points to the last element in the list is asserted, as shown in FIG. 5 and the program is run on harvested energy with EDB attached. EDB's console reports the assertion failure, halts the program, starts to continuously power the target device, and opens an interactive debug session. This sequence is captured in the oscilloscope trace in FIG. 6B. The discharge cycle on the right is the one during which the assert fails at instant 1 and the capacitor voltage is seen rising to the level of the tethered power supply.

The interactive debug session is shown on the right in FIG. 5. The internal state of the target device is checked using EDB's commands for inspecting target device memory. The tail pointer points to the penultimate element instead of the last one, which is a consequence of an append function interrupted by intermittence. Because of this inconsistency, the else-clause in the remove function would dereference a NULL pointer, read the buffer pointer from an invalid location, and cause the memset function to write to a wild pointer and corrupt non-volatile state beyond recovery. The assert and the interactive session uncovers the inconsistency in the data structure before any of the confounding consequences could take place.

Instrumenting Code With Consistency Checks—

To aid in debugging, applications often have separate debug and release build configurations. A debug build includes instrumentation code such as checks for consistency of data structures or array bounds. On continuously-powered platforms the convenience of the debug build comes at the cost of slower execution speed, higher memory usage, and higher energy consumption. However, on intermittently-powered platforms, the effect is more critical: the energy overhead imposed by the instrumentation can render an application non-functional by preventing it from making any forward progress. Yet, instrumented energy-harvesting applications must be run on harvested energy to diagnose intermittence-induced bugs, since these bugs are invisible while the device is continuously powered. This example demonstrates how an application can be instrumented with debug code of arbitrary energy cost using EDB's energy guards.

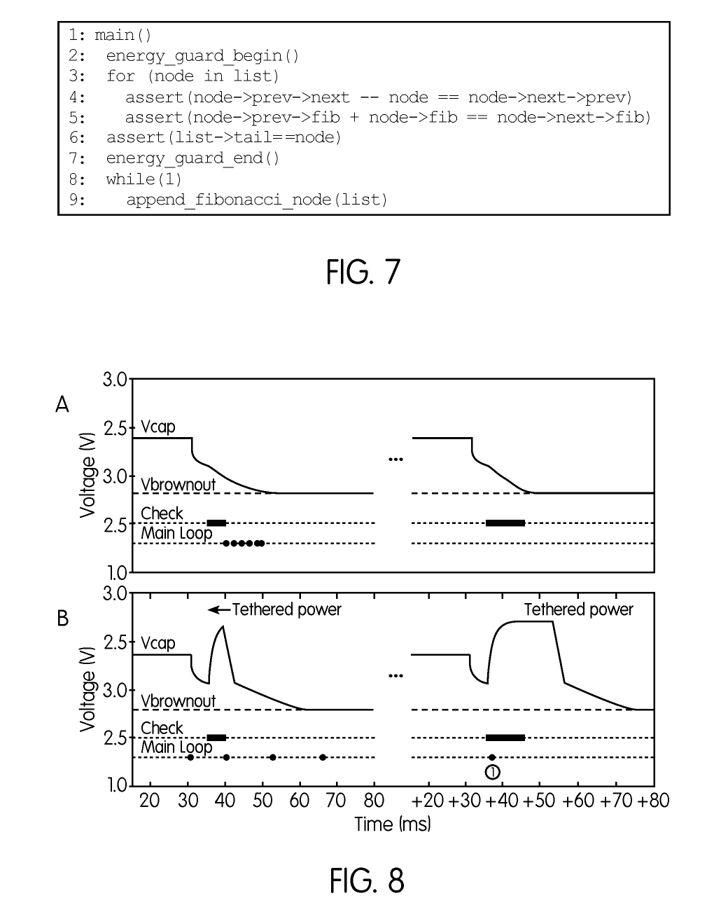

The code snippet shown in FIG. 7 generates the Fibonacci sequence and appends each number to a non-volatile, doubly-linked list. For illustrative purposes, each iteration of the main loop toggles a GPIO pin to track progress. In the debug build, main begins with an energy-intensive consistency check that traverses the list and asserts that the previous pointers, the next pointers and the Fibonacci value in each node are consistent. This invariant helps detect problems early, before they precipitate into failures of unknown cause or origin. With intermittent power, the invariant was violated.

The application's release build produces an inconsistent list without any indication that there is a problem. The debug build stops executing the main loop after having added approximately 555 items to the list. The trace in FIG. 8A shows an early charge cycle when the main loop executes and a later one when it no longer does.

The energy cost of the consistency check is proportional to the length of the list. Once the list is long enough, the consistency check consumes all of the energy available in one charge-discharge cycle and leaves none for the main loop. Once reached, this hung state persists indefinitely because the application cannot make progress in subsequent charge-discharge cycles.

EDB lets the developer keep the consistency check without breaking application functionality by wrapping the check with energy guards as shown in FIG. 7. The effect this has on the energy state of the target device is captured in the oscilloscope trace shown in FIG. 8B. At instance 1, the code in the target device enters the energy guard, and EDB tethers it to a power supply. The capacitor starts charging while the code in the target device continues executing within the energy guard. At instance 2, the code in the target device exits the energy guard, and EDB cuts the power supply and starts to discharge the capacitor to the level it had at instance 1. After the discharge completes, the code in the target device is allowed to continue execution. This sequence of events later takes place again between instances 3 and 4. With the energy guard around the consistency check, the main loop gets the same amount of energy in both early charge-discharge cycles when the list is short (left) and later ones when it is longer (right).

Tracing Events and Profiling Energy Cost—

The intermediate results of calculations, frequency of events, and energy cost of operations are valuable clues for quick diagnosis of erroneous code. Directly extracting such information from an energy-harvesting device using existing tools changes the behavior of the application. As an example, the sampling rate of a sensing application may increase by a factor of 100-1000 when powered continuously in the lab relative to when harvesting energy in a realistic deployment. This section demonstrates how EDB's energy-interference-free printf function and watchpoints can view the internals of running code with minimal impact on application behavior.

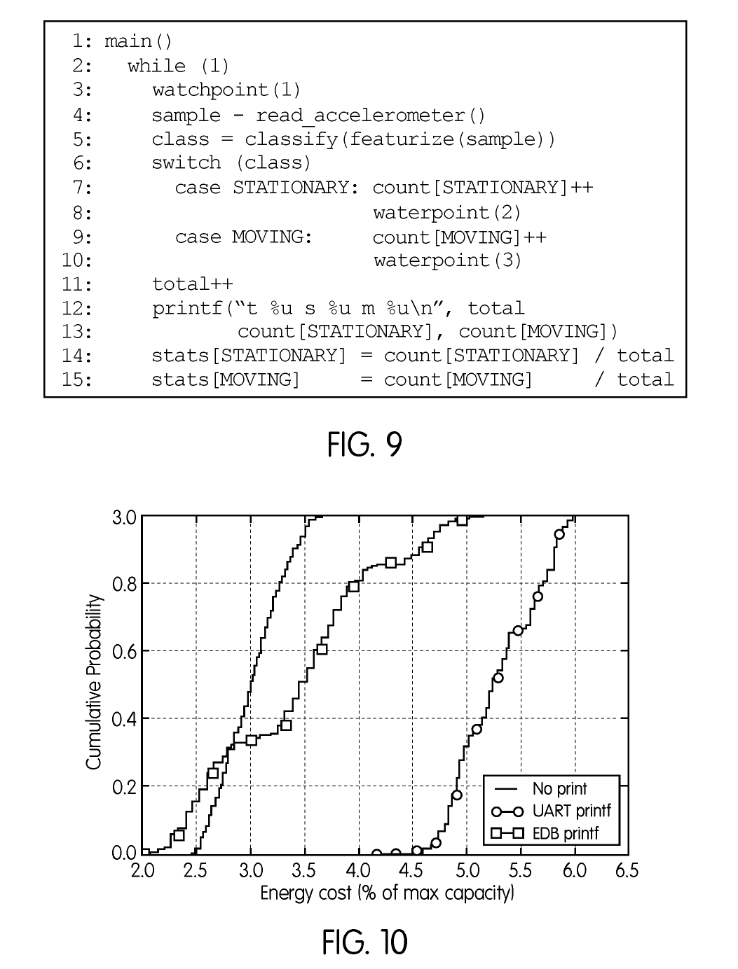

The code snippet of an activity recognition application shown in FIG. 9 reads an accelerometer sample, classifies the sample as “stationary” or “moving”, and records statistics in non-volatile memory. There is no evidence that the recorded statistics are based on correct accelerometer readings and classification results. Moreover, the application cannot be tuned to the size of the storage capacitor without the energy profile of one classification operation.

Information can be extracted from the target device either over a traditional debugger interface or using I/O peripherals (e.g. UART or GPIO ports). To relay a data stream via a traditional debugger, the target device must be on during the entire debugging session. Off-the-shelf USB-to-serial adapters are not electrically isolated from the target UART and permit energy to flow into or out of the target device. Encoding information onto GPIO pins and decoding it using an oscilloscope requires significant effort compared to a printf call that outputs text to a console on the host.

The measurements in Table 2 demonstrate the impact on application behavior of using a UART. The energy cost of the printf statement changes the iteration success rate (i.e. the fraction of iterations that successfully complete out of the total attempted). To trace application progress without disrupting its behavior, the loop body was instrumented with an EDB printf and three watchpoints as shown in FIG. 9. The printf produces a stream of intermediate classification results for each iteration. The watchpoints produce a time and energy profile of a loop iteration as well as an independent calculation of the statistics useful for manual verification. The energy profile shown in FIG. 10 can be calculated from the difference between energy level snapshots taken by watchpoints 1 and 2, and watchpoints 1 and 3. Reference classification statistics can be calculated by counting occurrences of watchpoints 2 and 3.

TABLE 2
Cost of debugging output and its impact on
the bahavior of the activity recognition application.

| | | |
|---|---|---|
| Iteration | Iteration Cost | Print Cost |

| | Success | Energy | Time | Energy | Time |
|---|---|---|---|---|---|
| | Rate | (%*) | (ms) | (%*) | (ms) |
| No print | 87% | 3.0 | 1.1 | — | — |
| UART printf | 74% | 5.3 | 2.1 | 2.5 | 1.1 |
| EDB printf | 82% | 3.4 | 4.7 | 0.11 | 3.1 |

*Energy cost is reported as percentage of 47 μF storage capacity.

Debugging and Tuning RFID Applications—

Energy-harvesting applications that communicate using the RFID protocol are difficult to debug without simultaneous visibility into communication and energy state. This example demonstrates how EDB can monitor RFID I/O messages and correlate them with available energy.

The example RFID firmware decodes RFID query commands from a reader in software and replies with a unique identifier. The application and reader cannot be characterized and tuned without a measure of the target device's performance in different RF environments (e.g. the number of responses per queries received). Correctness cannot be verified without evidence that the application software successfully decodes and acts on each valid incoming query message.

Both tasks require a trace of incoming messages that reached the target device, for example, bit patterns in the incoming de-modulated waveform that could have been decoded into valid messages by software. An oscilloscope trace of the raw output from the RF demodulator does not reveal whether the waveform is decodable into a valid message. A decoder is necessary to separate messages that were corrupted in flight from valid messages that the target application failed to parse.

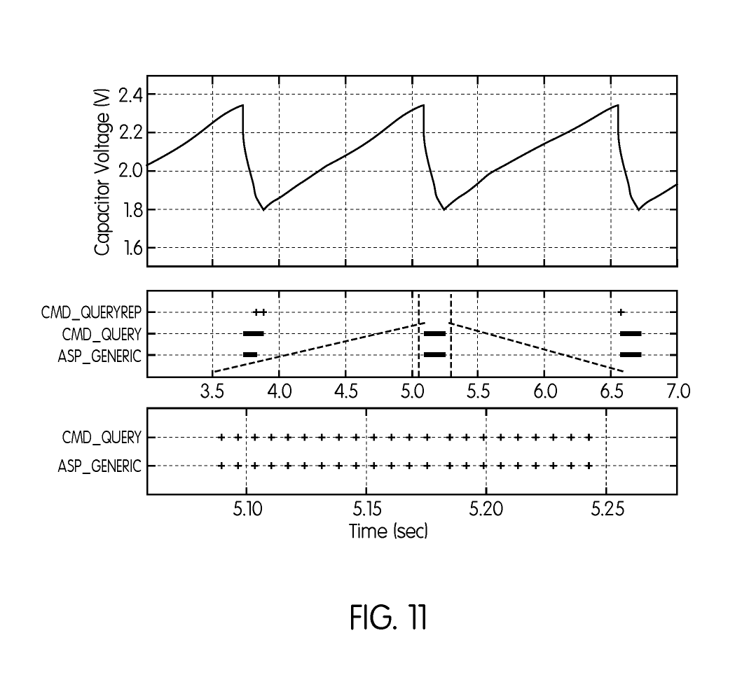

EDB can be used to stream RFID message identifiers and target device energy readings to the host. The data plotted in FIG. 11 shows that the application responded 86% of the time for an average of 13 replies per second. The view focused on one discharge cycle confirms that the application successfully received consecutive incoming query messages and replied. To produce such a mixed trace of I/O and energy using existing equipment, the target would have to be burdened with logging duties that exceed the computational resources left after message decoding and response transmission.

Intermittently executing, energy-harvesting devices present unique system reliability challenges, and the EDB system presented herein is the first debugging system designed to address those challenges. Energy-interference freedom as a property is essential to the utility of a debugging platform for energy-intermittent systems and EDB provides such a capability. EDB supports passive monitoring of a target device's energy, software events, and I/O. Using its ability to manipulate a target device's energy, EDB also supports active debugging tasks with energy-interference freedom, including assertions, instrumentation, breakpointing, tracing, and interactive debugging. A prototype of EDB, including custom hardware, was evaluated and proved to be energy-interference-free in both passive and active tasks, and was able to provide invaluable debugging information that is out of reach using existing tools and techniques.

EDB has been explained in terms of functionality as well as with actual implementation details of the hardware and software. Although prototype EDBs have been built, many hardware and software implementations of EDB are possible without deviating from the intended scope of the invention, which is specified in the claims which follow.

We claim:

1. A device for debugging target software executing on an energy-harvesting target device comprising:
a processor;
an energy source independent from the target device;
a plurality of I/O lines connected to the target device;
software, executing on the processor, the software providing various debugging functions;
wherein one of the plurality of I/O lines is connected to a regulated power line of the target device and one of the plurality of I/O lines is connected to an energy-storage capacitor on the target device;
wherein the charge level available on the target device can be monitored and controlled via the I/O lines connected to the regulated power line and the energy storage capacitor of the target device; and
wherein the target device can be powered via the energy source on the device.

2. The device of claim 1 wherein the charge level available on the target device can be increased by charging energy-storage capacitor on the target device from the energy source of the device and decreased by discharging the energy-storage capacitor on the target device through a fixed resistive load on the device.

3. The device of claim 1 wherein the software provides both passive mode and active mode debugging;
wherein the passive mode provides streams of data for correlating changes in system, behavior to changes in the charge level of the energy-storage capacitor on the target device; and
wherein the active mode provides the ability to manipulate the charge level on the of the energy-storage capacitor on the target device.

4. The device of claim 3 wherein the streams of data include charge level of the energy-storage capacitor on the target device, I/O events on wired busses, messages exchanged over RFID and program events marked by watchpoints in the target software.

5. The device of claim 3 wherein active mode allows the performance of an active tasks in which:
a charge level of the energy storage capacitor on the target device is read and stored;
the active task is performed; and
the energy storage capacitor on the target device is restored to the stored charge level.

6. The device of claim 5 wherein the software performs the further function of powering the target device from the energy source on the device during the performance of the active task.

7. The device of claim 5 wherein the active task comprises interfacing with the target device via the plurality of I/O lines to perform debugging functions of the target device.

8. The device of claim 5 wherein the active task is providing energy guards for a guarded portion of the target software comprising:
placing energy guards before and after a guarded portion of the target software; and
allowing the guarded portion of the target software to execute; and

9. The device of claim 5 wherein the active task is providing a breakpoint at a specified point in the target software.

10. The device of claim 5 wherein the active task is providing an energy breakpoint that triggers when the charge level in the energy storage capacitor of the target device falls below a pre-determined level.

11. The device of claim 5 wherein the active task is providing a combined breakpoint that triggers at a specified point in the target software when the charge level in the energy storage capacitor of the target device falls below a pre-determined level.

12. The device of claim 5 wherein the active task is providing a keep-alive assertion which, upon failure of an assertion condition powers the target device from the energy source on the device.

13. The device of claim 1 wherein the software provides the function of providing assertions, watchpoints and breakpoints in the target software triggered by the charge level available in the energy storage capacitor on the target device.

14. The device of claim 1 wherein the software provides the function of providing monitoring of I/O via the plurality of I/O lines connected to the target device.

15. The device of claim 1 wherein a low-leakage buffer is used on the I/O lines to prevent leakage current between the device and the target device, and a level shifter to match a voltage level of the buffer to a voltage level on the target device.

16. The device of claim 1 further comprising software, executing on the target device to provide a library of debugging macros callable from the target software.

17. The device of claim 16 wherein the debugging macros include inserting assertions, breakpoints, watchpoints, energy guards and printf calls into the target software.

18. The device of claim 16 wherein the library implements a protocol on the target device for communicating with the device over one or more I/O lines.

19. The device of claim 16 wherein the library allows the device to read and write memory of the target device.

20. The device of claim 1 further comprising a monitor providing a user interface via which a user can interact with the device and the target device to perform debugging functions.

21. A method for debugging target software on an energy-harvesting target device comprising:
reading and storing an energy level available on the target device;
performing one or more debugging activities; and
restoring the energy level on the target device to the stored level.

22. The method of claim 21 further comprising powering the target device during the debugging activities from an external source of power.
